(19) United States
(12) Patent Application Publication
(10) Pub. No.: US 2001/0030402 A1
(43) Pub. Date: Oct. 18, 2001

(54) All-terrain wheeled vehicle

(76) Inventor: Timothy P. White, New Boston, NH (US)

Correspondence Address: BOURQUE & ASSOCIATES, P.A., Suite 303, 835 Hanover Street, Manchester, NH, 03104, US

(21) Appl. No.: 09/737,281

(22) Filed: Dec. 14, 2000

Related U.S. Application Data
(60) Provisional application No. 60/170,687, filed on Dec. 14, 1999.

(51) Int. Cl. B62B 1/00

(52) U.S. Cl. 280/47.25; 280/63

(57) ABSTRACT

An all-terrain wheeled vehicle. The wheeled vehicle includes a frame having a handle assembly, which is configured to allow a person to propel the wheeled vehicle by either pulling or pushing the vehicle, and a pair of large diameter wheels provided on opposite sides of the frame. Intermediate the wheels, mounted on the frame is a load carrier, such as a stretcher, chair or basket. The wheeled vehicle includes a wheel positioning system including a wheel track adjuster and individually adjustable wheel height adjusters for varying the height of each of the vehicle wheels with respect to the lad carrier. Optional power assisted drive and braking mechanisms are also provided.

### RELATED APPLICATIONS

This application claims benefit of U.S. Provisional Application Ser. No. 60/170,687 filed Dec. 14, 1999, fully incorporated herein by reference.

### FIELD OF THE INVENTION

The present invention relates to vehicles for use in transporting disabled individuals. More particularly, the invention concerns an all-terrain wheeled vehicle in the form of a rickshaw, which can be used by an able bodied individual to pull a load, such as a disabled person, along a path, trail or other rough terrain.

### BACKGROUND OF THE INVENTION

In the past, persons suffering from conditions that have adversely effected their ability to walk have been unable to engage in many activities that able-bodied individuals take for granted. One such activity is a simple walk along a path or trail through the woods. Since the majority of wheeled vehicles, which are designed to carry disabled persons include relatively thin wheels and small diameter front casters, which are designed to facilitate movement on hard surfaces, these vehicles are unsuitable for use on rough terrain.

Accordingly, in the recent past, many attempts have been made to design vehicles that are more suitable for use on rough terrain and are, therefore, useful to disabled persons seeking to visit rough, natural areas. For example, U.S. Pat. No. 5,518,081, which issued to Thibodeau on May 21, 1996, discloses an all-terrain and all-weather wheelchair which includes a frame and a seat and has drive wheels mounted to the rear of the frame independently rotatable and operable to both drive and steer the chair. The Thibodeau patent also includes a suspension system, which is designed to absorb the shock of travel over rough terrain. However, devices, such as the Thibodeau all-terrain wheelchair, are extremely complex and expensive vehicles. Additionally, since such vehicles are self-propelled, they require sophisticated drive systems and heavy batteries in which to power DC motors.

Additional attempts at making rough terrain accessible to wheelchair-bound individuals include attachments for conventional wheelchairs that allow them to be pulled into rough terrain. One example of such an invention is U.S. Pat. No. 5,470,093, which issued to Kiser on Nov. 28, 1995. The Kiser invention concerns an auxiliary wheelchair attachment for pulling a wheelchair. Thus, by equipping a conventional wheelchair with such an attachment, a disabled person can be pulled by an attendant along a path or trail. However, since the Kiser invention concerns a device that can be adapted to a conventional wheelchair, such a device still suffers from the deficiencies created by the relatively thin wheels provided on conventional wheelchairs. In addition, such a device does not address stability concerns created by relatively high centers of gravity. Accordingly, even a wheel chair adapted with the Kiser invention would not be acceptable for rough, sloping terrain.

Countless other attempts at providing accessibility to rough terrain to wheelchair-bound individuals all suffer from the same deficiencies noted earlier, and, although all such devices do allow disabled persons to visit more terrain than would otherwise be accessible to them, the increase in the amount of accessible terrain is still somewhat limited.

FIG. 1 provides a graphical representation of accessibility to disabled persons as a function of terrain complexity. In addition, FIG. 1 also graphically depicts the degree of participation available to such persons as such terrain is encountered. For example, a person utilizing an assisted wheelchair is limited to relatively simple terrain, such as pavement, and such an individual would be dependent upon an attendant or other assistant in order to access such terrain. On the other hand, a motorized wheelchair would allow an individual to be much more independent. A cross-country wheelchair would allow more complex terrain to be accessible. However, as can be seen, none of the available devices would make deep woods accessible to disabled persons.

Accordingly, what is needed is a vehicle for use with disabled persons, which would allow complex terrain to be readily accessible by disabled persons. Preferably, such a device would be an attendant-assisted vehicle, which, although it would not allow a disabled person to be fully independent, it would allow such a person to participate as a contributing member of a team exploring complex terrain.

### SUMMARY OF THE INVENTION

The present invention provides an all-terrain wheeled vehicle, which features a frame having a handle assembly extending from a first end thereof. The handle assembly is configured to allow a person to propel the wheeled vehicle. The vehicle also has a pair of large diameter wheels disposed on opposite sides of the frame. A load carrier, such as a chair, stretcher or load platform, is disposed intermediate the pair of large diameter wheels. Finally, the all-terrain wheeled vehicle of the present invention features a wheel positioning system, which includes a wheel track adjuster for adjustably positioning the wheels a desired distance from each other and a wheel height adjuster for individually adjusting the height of each of the large diameter wheels with respect to the load carrier.

Accordingly, the disclosed all-terrain wheeled vehicle can be propelled through rough terrain, including along severe slopes, through narrow passageways, and can straddle large objects, such as rocks and stumps. Thus, the all-terrain wheeled vehicle of the present invention makes areas that were previously inaccessible to disabled persons readily accessible. In the preferred embodiment, the disclosed invention is pulled by an attendant, in a manner similar to a rickshaw.

### DESCRIPTION OF THE DRAWINGS

These and other features and advantages of the present invention will be better understood by reading the following detailed description taken together with the drawings wherein:

FIG. 1 provides a graphical representation of terrain accessibility available to various forms of wheeled vehicles available to disabled persons;

FIG. 2 is a side-view of one embodiment of an all-terrain wheeled vehicle according to the present invention;

FIG. 3 is a side view of one embodiment of a suspension wheel utilized by the all-terrain wheeled vehicle of the present invention;

FIG. 4 is a detailed view of one suspension spoke utilized by each suspension wheel of the wheeled vehicle of FIG. 3;

FIGS. 5A and 5B show alternative means of attaching the wheeled spokes of each suspension wheel of FIG. 3 to form a complete wheel spoke and rim combination;

FIG. 6 shows one embodiment of a wheel hub for accepting the spokes of a suspension wheel utilized by the present invention;

FIG. 7 shows a second embodiment of a wheel hub for accepting the spokes of a suspension wheel utilized by the present invention;

FIG. 8 is a side view of the wheel hub of FIG. 7;

FIG. 9 is a close up view of a second embodiment of a fastener for removably attaching each suspension spoke to a wheel hub assembly;

FIG. 10 is a close up view of a receiver included on the wheel hub assembly of FIG. 7 for accepting a suspension spoke fastener of FIG. 9;

FIG. 11 is a second embodiment of a suspension wheel, including a stiffer inner section and a more flexible outer section;

FIG. 12 is another embodiment of a suspension wheel, including a stiffer inner section and a more flexible outer section;

FIG. 13 is a perspective view of the components of a modular wheel kit used to construct the suspension wheel of FIG. 12;

FIG. 14 is a side view of one assembled wheel spoke of the modular wheel kit of FIG. 13;

FIG. 15 is a representation of a wheel stiffness profile for the suspension wheels of FIGS. 11 and 12;

FIG. 16 is a graph showing wheel stiffness profiles of different types of wheels;

FIG. 17 is a side view of a suspension wheel according to FIG. 12 under light load conditions;

FIG. 18 is a side view of a suspension wheel according to FIG. 12 under heavy load conditions;

FIG. 19 is a side view of a suspension wheel according to FIG. 12 rolling across an obstacle, such as a fallen tree;

FIG. 20 is a front view of one embodiment of a wheeled vehicle according to the present invention showing components of the wheel positioning system of the present invention in a narrow track, low center of gravity position;

FIG. 21 is a front view of the all-terrain wheeled vehicle accordingly to the present invention showing the wheel positioning system components in an obstacle straddling position;

FIG. 22 is a front view of the all-terrain wheeled vehicle of the present invention showing the wheel positioning system in a wide track, slope-traversing position;

FIG. 23 is a front view of an all-terrain wheeled vehicle according to the present invention showing the wheel positioning system in a narrow track, slope-traversing position;

FIG. 24 shows one embodiment of a wheeled positioning control system according to the present invention;

FIG. 25 is a side view of one embodiment of an all-terrain wheeled vehicle according to the present invention including a power assisted drive mechanism; and

FIG. 26 is a top view of a drive hub of the embodiment of FIG. 25 showing a drive motor engaged therewith along with a frictional braking system.

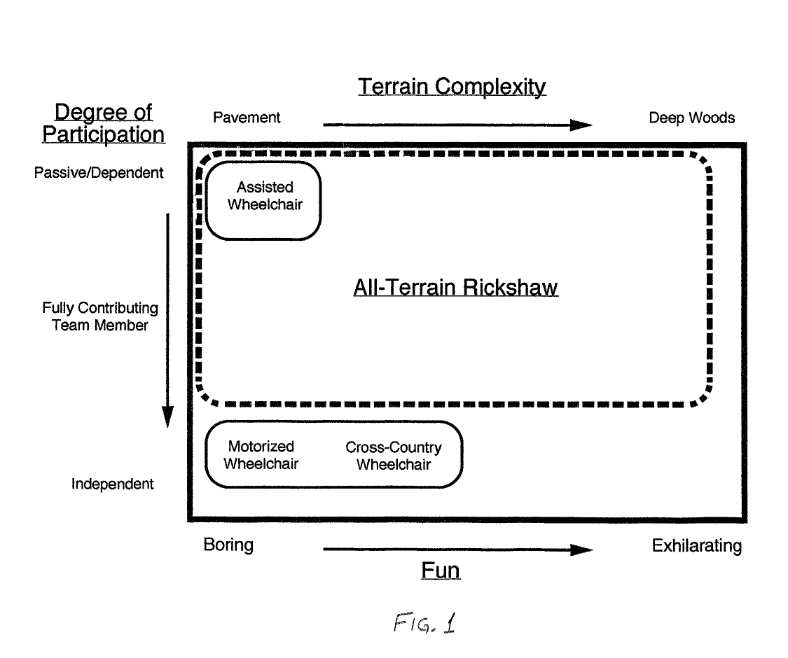

### DETAILED DESCRIPTION OF THE INVENTION

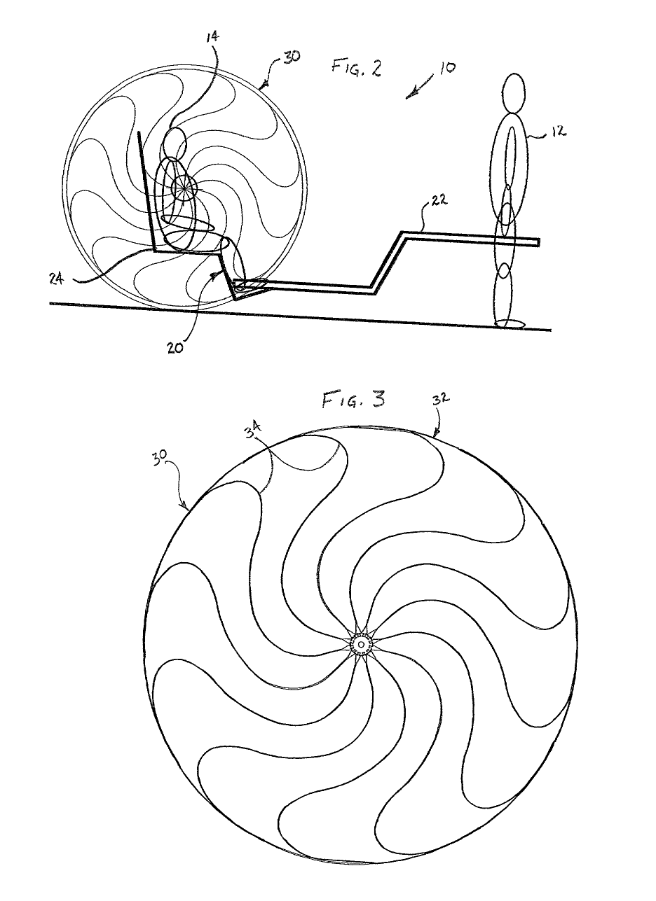

Turning now to the figures an all-terrain wheeled vehicle 10 is shown. In one embodiment, the all-terrain wheeled vehicle 10 is in the form of a rickshaw whereby an attendant 12 pulls a passenger 14 riding in the rickshaw. The wheeled vehicle 10 includes a frame 20 having a handle assembly 22 extending from a first end thereof. In the embodiment of FIG. 2, the handle assembly allows the attendant 12 to propel the wheeled vehicle by lifting and pulling the handle assembly 22. Preferably, the wheeled vehicle is balanced so that the majority of the weight being carried by the vehicle is supported by the vehicle wheels 30 so that the amount of lifting force required by the attendant 12 is kept to a minimum.

The wheeled vehicle 10 also includes at least one pair of large diameter wheels 30, which are disposed on opposite sides of the vehicle frame 20. Various embodiments of the large diameter wheels 30 will be described in more detail below.

Disposed intermediate the large diameter wheels is a load carrier 24. In the embodiment shown in FIG. 2, the load carrier is a chair, which allows a person to sit in the wheeled vehicle and be pulled in a sitting position. However, alternate embodiments of the invention may include differing forms of load carriers. For example, one embodiment of the invention, which would be configured to carry loads, such as luggage, tools, building materials or the like, may include baskets or other platforms for carrying such articles. Another embodiment, which would be configured for carrying injured persons out of rough terrain could include a stretcher assembly as the load carrier disposed intermediate the large diameter wheels 30. In any event, by carrying a load intermediate the large diameter wheels, the disclosed all-terrain wheeled vehicle is extremely stable. As will become for fully apparent below, additional features of the disclosed invention will further aid in the stability and versatility of the disclosed vehicle.

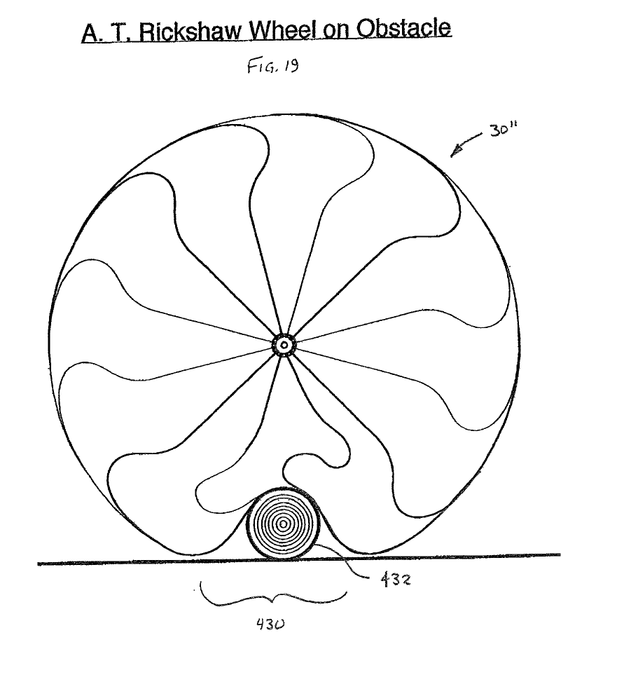

The all-terrain wheeled vehicle 10 of the present invention also includes a wheel positioning system 40 (FIGS. 19 through 23). The wheel positioning system 40 includes a wheel track adjuster 42 for adjustably positioning the wheels 30 a desired distance from each other. The wheel positioning system also includes a wheel height adjuster 44 for each wheel. Therefore, the height of each large diameter wheel 30 may be individually adjusted with respect to the load carrier 24.

In order to allow the vehicle to carry a load over rough terrain, the large diameter wheels 30 included on the vehicle preferably have a diameter substantially greater than five feet. In addition, since the all-terrain wheeled vehicle 10 will not be propelled at excessively fast speeds (since it will preferably be propelled by a person either pulling or pushing the vehicle), the large diameter wheels 30 will preferably be suspension wheels. This will eliminate the need for a separate, suspension system, which would add unnecessary weight to the vehicle.

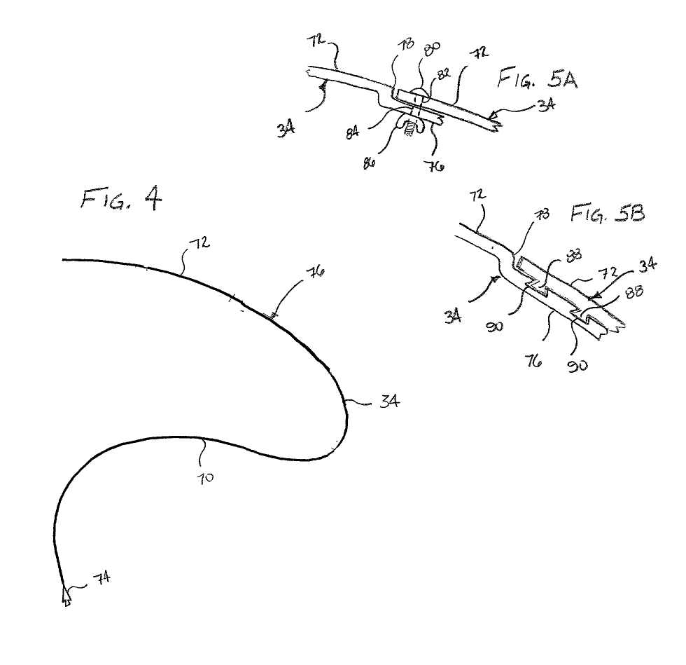

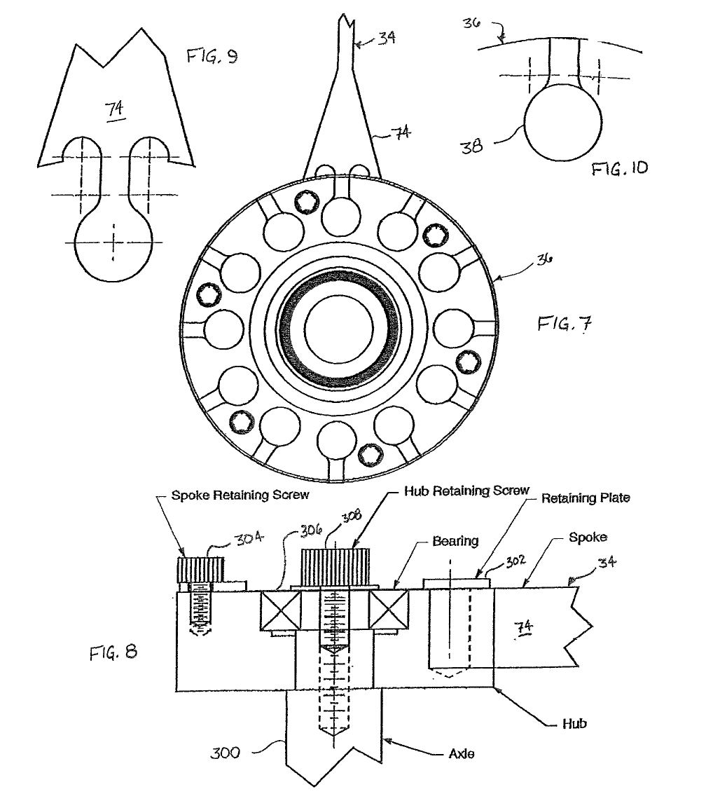

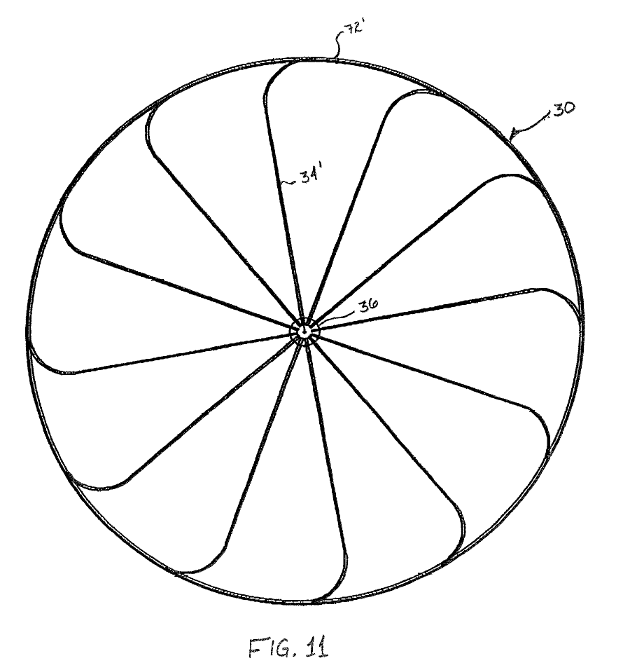

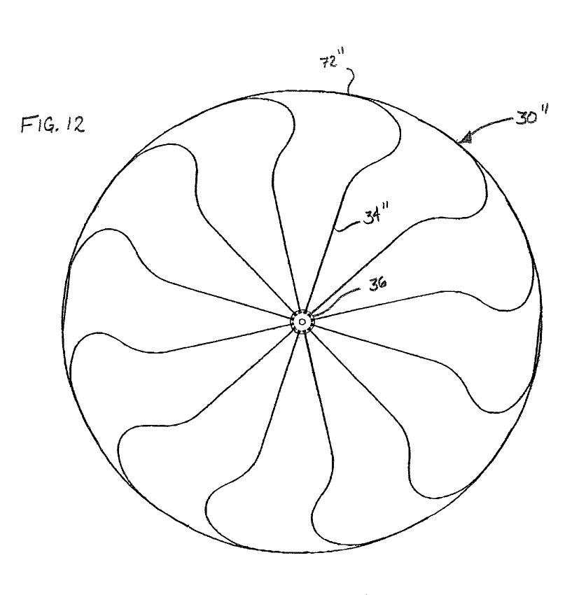

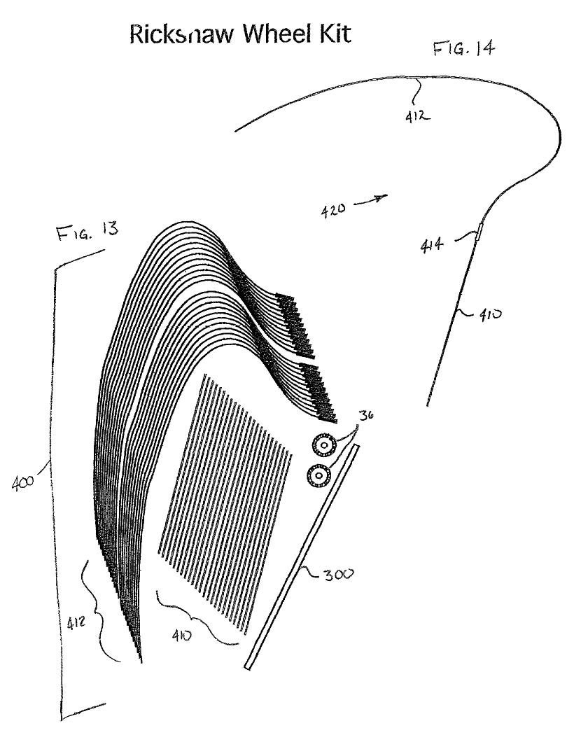

As shown in FIGS. 3-15 and 17-18, the large diameter suspension wheels 30 include a rim section 32 and a plurality of suspension spokes 34. In one embodiment, the large diameter suspension wheel 30 is made up of twelve suspension spokes 34, each of which includes a suspension section 70 and a rim section 72. At one end of the suspension section 70, a quick-release fastener 74 is provided for removably attaching each suspension spoke 34 to a receiver 38 is a wheel hub assembly 36. The wheel hub assembly 36 includes a receiver 38 for each suspension spoke 34. Each suspension spoke 34 also includes a mating section 76, where the rim sections of adjacent spokes are attached in order to form a substantially circular wheel. By assembling the plurality of spokes 34, a complete wheel assembly is formed, including an integral rim formed by the rim sections 72 of the spokes 34.

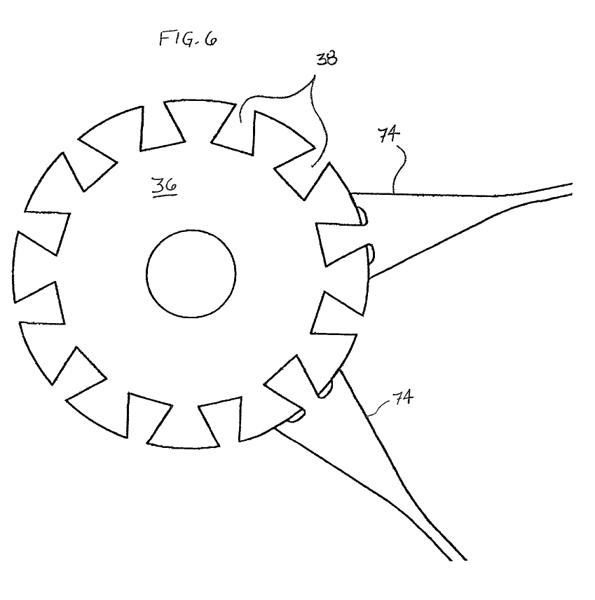

Alternative means of fastening or attaching the spokes 34 to each other to form each wheel 30 are envisioned. In one example, a threaded fastener 80 may be provided for insertion through corresponding holes 82 and 84 in each spoke rim section 72 and mating section 76, respectively. Once inserted through the corresponding holes 82 and 84, the fastener 80 is held in place using a nut 86. As shown in FIGS. 5A and 5B, the mating section 76 of each spoke 34 communicates with its respective rim section 72 at an angled section 78, which allows each adjacent rim section 72 to form a substantially smooth wheel rim.

FIG. 5B shows an alternative system for fastening adjacent wheel rim sections. In this embodiment, each wheel rim section 72 is provided with one or more dovetail tabs 88, which engage corresponding dovetail recesses 90 in a mating section 76 of an adjacent wheel spoke 34.

Of course, alternative embodiments may be suitable for joining adjacent wheel spokes to form a complete wheel assembly. By providing modular wheel assemblies, the largest section of the disclosed all-terrain wheeled vehicle, namely the wheels 30, can be disassembled to facilitate transportation of a partially or totally disassembled vehicle into remote areas using a backpack or the like.

FIGS. 7-10 show the components of another embodiment of the hub assembly 36, how the suspension spokes 34 are attached thereto and how the hub assembly 36 is attached to a vehicle axle 300. Like the hub assembly of FIG. 6, the hub assembly 36 of this embodiment includes a plurality of receivers 38, which are of a size and shape to accept a corresponding fastener 74 provided on a hub end of each suspension spoke 34. In the embodiment shown, twelve receivers 38 are provided for receiving twelve corresponding suspension spokes 34.

Once the fasteners 74 for all of the spokes 34 being utilized are inserted into their corresponding receivers 38, a retainer plate 302 is placed on top of the hub assembly and is fastened thereto using a plurality of retainer plate fasteners 304. The retainer plate prevents the wheel spokes from becoming dislodged from the hub assembly 36 while the vehicle is being utilized.

Also provided is a wheel bearing 306 for each wheel 30, which communicates with the wheel hub assembly 36 and the axle 300 to allow the suspension wheel 30 to rotate freely about the axle 300. The wheel bearing is retained in position using a hub retaining fastener 308.

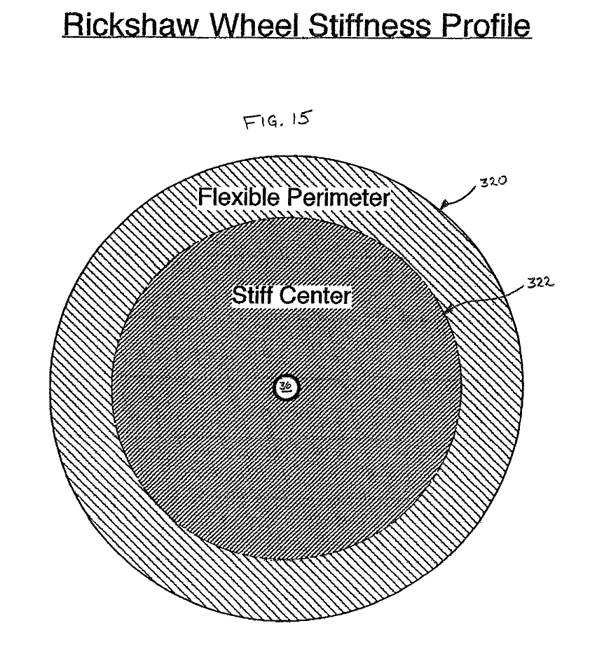

FIG. 11 shows an alternative embodiment of a suspension wheel 30′ including suspension spokes 34′, which are more rigid near the hub assembly 36 and are more flexible near their rim sections 72′.

FIG. 12 shows a more sophisticated embodiment of a suspension wheel 30″, which is configured to exhibit varying flex characteristics as near the hub assembly 36 and the wheel rim. As with the embodiment of FIG. 11, the suspension spokes 34″ of this embodiment are stiffer near the hub assembly 36 and are more flexible near their rim sections 72″.

FIGS. 13 and 14 show one preferred embodiment of a wheel/axle kit 400 utilizing suspension wheels 30″ according to FIG. 12. In this embodiment, each kit 400 includes the components necessary to construct two wheels to be mounted on an axle 300. This embodiment is especially useful in situations where a person would desire to carry the kit in a broken-down state in a backpack or the like. Thus, a wheeled vehicle could be more readily transported into remote areas where it could be assembled for use.

Each kit 400 includes suspension spoke components 410, which include central, substantially rigid spoke sections 410 and peripheral, flexible sections 412. Each spoke 420 (FIG. 14) is assembled using one rigid spoke section 410 and one peripheral spoke section 412. The two sections are joined using a connector 414, which may be provided as an integral portion of one of the spoke sections. The connector 414 may include a spring tab to hold the two sections together and allow them to be disassembled without the use of tools. Alternatively, the spoke sections may be assembled in a manner similar to that described above with respect to FIGS. 5A and 5B. Each kit 400 also includes an axle 300 and two hub assemblies 36 of the type described above.

Each wheel is assembled in a manner similar to that described earlier by joining a plurality of spokes 420 to each hub assembly 36 and then joining each spoke peripheral section 412 to an adjacent peripheral section to form the wheel rim. The two wheels are then counted to the axle 300 at their respective hub assemblies.

Of course, a wheel kit 400 may be used in conjunction with additional modular kits, which would provide load platforms and the like, which would be axle-mountable. In this manner carts could be constructed in remote areas, which could be pushed or pulled by a person to move heavy loads in remote areas.

FIG. 15 shows, in graphical form, a wheel stiffness profile of suspension wheels using the configuration of FIGS. 11 and 12. As can be readily seen, these suspension wheels have a flexible perimeter section 320 and a stiff center section 322. This graphical depiction clearly shows how a suspension wheel utilizing this configuration mimics a more conventional pneumatic wheel/tire assembly, including a rigid wheel surrounded by an inflatable pneumatic tire. However, unlike such conventional pneumatic wheel/tire assemblies, the disclosed suspensions wheels are not susceptible to puncture when utilized in rough terrain.

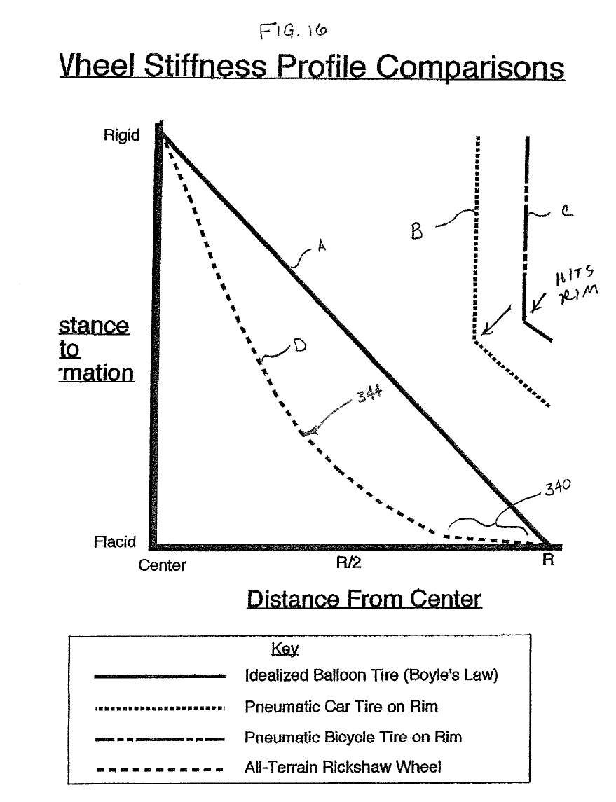

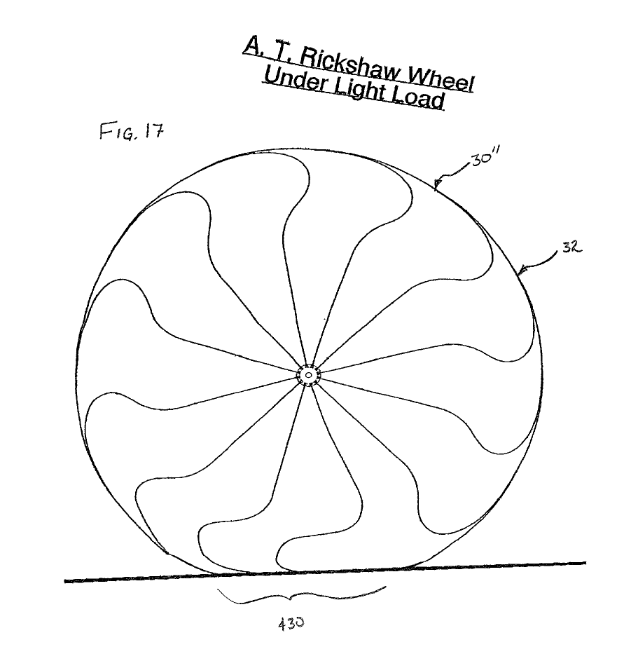

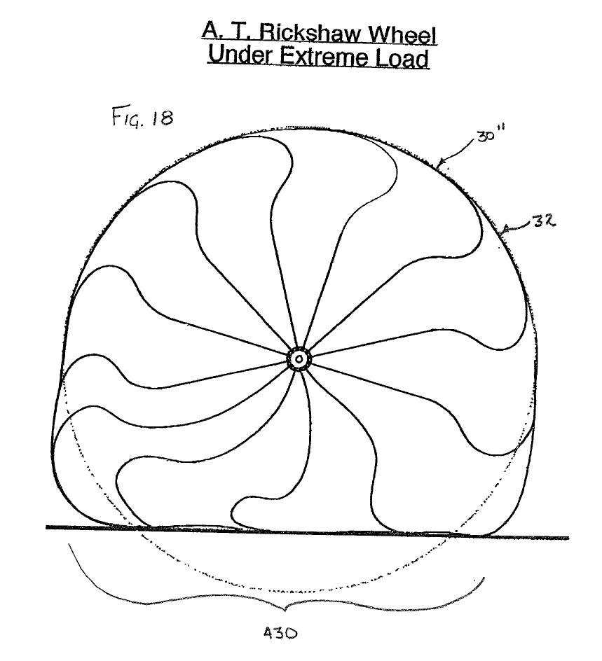

Turning now to FIG. 16, wheel stiffness profiles for various types of wheels are provided in a graphical format showing resistance to deformation as a function of the distance from the center of the wheel. Curve A shows an idealized balloon tire functioning according to Boyle's law. With this type of balloon tire, its resistance to deformation curve is substantially a straight line having its most rigid point at its center and its most flexible point at its periphery.

Curve B shows a pneumatic wheel/tire assembly, such as an automobile wheel and tire having a rigid rim to which a pneumatic tire is mounted. As can be seen, this type of wheel/tire assembly functions according to Boyle's law at its peripheral section, where the pneumatic tire is mounted and then exhibits a substantially vertical rise to its maximum rigidity at beginning where the rim is encountered and proceeding inwardly towards the wheel hub. Curve C shows a pneumatic bicycle tire on a rim assembly. This type of assembly exhibits characteristics similar to the automobile type wheel/tire assembly shown in curve B.

On the other hand, curve D shows the characteristics of a suspension wheel according to the embodiments of FIGS. 11 and 12. In this curve, an area of maximum flexibility 340 is shown near the periphery of the wheel. This section exhibits almost uniform flexibility. Then, as the suspension wheel is traversed inwardly towards the hub assembly, the more rigid portion of the suspension spokes is encountered. In this section 344, the rigidity of the wheel increases as the distance to the hub is reduced. However, unlike a rigid automobile or bicycle wheel, the increase in rigidity is gradual due to the deformability exhibited by the suspension spokes.

FIG. 17 shows a suspension wheel 30″ according to FIG. 12 exposed to a light load. As can be seen, the wheel shows a section communicating with the ground that is deformed to correspond to the topography of the ground being traversed. Under light loads, the deformed section 430 is rather small and the remainder of the wheel rim 32 is substantially retains its un-deformed, circular shape.

On the other hand, in FIG. 18, the suspension wheel 30″ is shown when it is exposed to a heavy load. In this situation, the ground-communicating, deformed section 430 is very large and may even communicate with the ground a distance greater than the un-deformed diameter of the wheel. When exposed to such heavy loads, a substantially smaller portion of the wheel retains its un-deformed, substantially circular shape.

FIG. 19 shows a suspension wheel rolling across an obstacle 432, such as a fallen tree. In this situation, the deformed section 430 of the suspension wheel 30″ corresponds substantially to the size and shape of the obstacle being crossed.

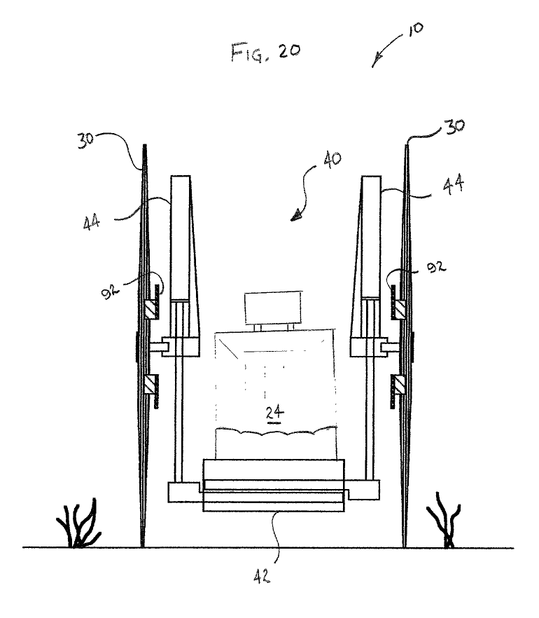

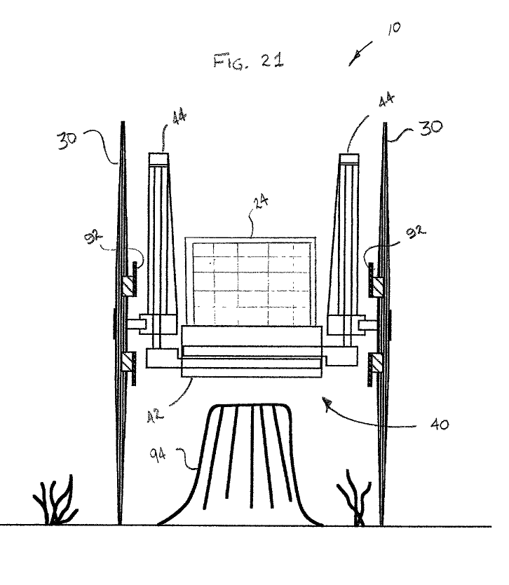

As indicated above, the all-terrain wheeled vehicle 10 includes a wheel positioning system 40 configured to adjust the track of the vehicle (the distance between the wheels) as well as the relative height of each wheel with respect to the load carrier 24. As shown in FIG. 20, the center of gravity of the all-terrain wheeled vehicle 10 can be very low by extending both wheel height cylinders, which raises both wheels 30 with respect to the load carrier 24 (or conversely, lowers the load carrier with respect to the wheels). In this figure, the track adjuster is shown in a narrow track position, whereby the wheels 30 are positioned as close to each other as possible. In this position, the wheeled vehicle 10 may negotiate tight areas. For example, the wheeled vehicle may fit between closely spaced trees, which are often encountered when traveling down a trail or path in the woods.

Also provided on each wheel are inner rim sections 92, which would allow an occupant of the wheeled vehicle to assist in propelling the vehicle or braking the vehicle when proceeding up or down slopes. In addition, as will be described in more detail below, optional power assisting/drive and braking systems, such as those provided for bicycles and the like, may be incorporated into the all-terrain wheeled vehicle of the present invention to provide greater assistance to a person propelling the vehicle.

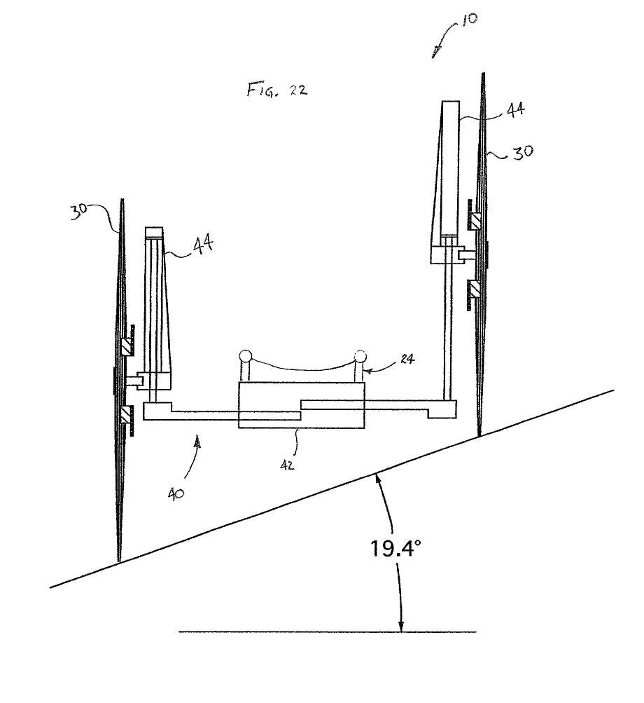

FIG. 21 shows an all-terrain wheeled vehicle 10 with its wheel positioning system 40 configured in an object-straddling mode. In this mode, both wheel height adjusters 44 are fully retracted so as to raise the load carrier 24 a maximum distance from the ground. Thus, the load carrier may straddle an obstacle 94, such as a stump, rock, boulder or the like.

In FIG. 22, the all-terrain wheeled vehicle 10 is shown in one slope-traversing mode. In this mode, one wheel height adjuster is retracted, while the opposite wheel height adjuster is extended. In this manner, the wheels 30 on opposite sides of the load carrier 24 are positioned at differing relative heights with respect to the load carrier 24. Accordingly, in this mode, the all-terrain wheeled vehicle 10 can traverse a slope while maintaining the load in an upright position. This enhances the stability of the vehicle and improves the comfort of a vehicle occupant. Also shown in FIG. 22, in this slope traversing mode, the wheel track adjuster 43 is fully extended so as to provide a maximum space between the large diameter wheels 30 to improve stability.

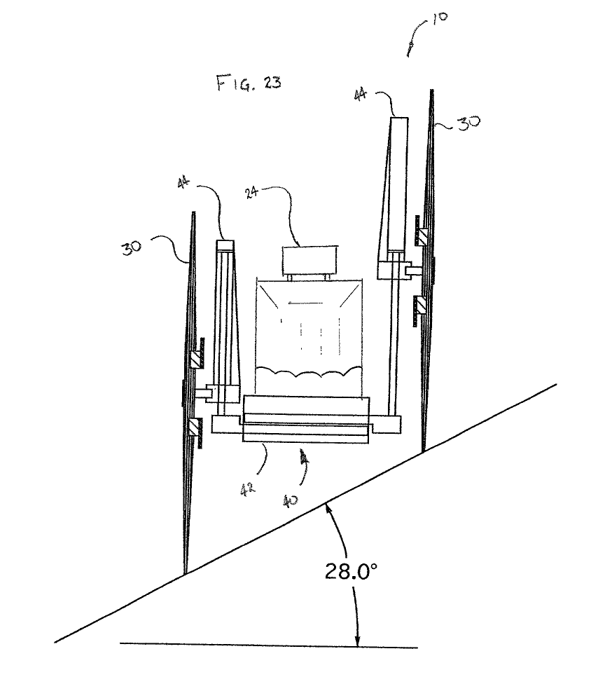

FIG. 23 shows the all-terrain wheeled vehicle 10 in a second slope-traversing mode. However, in FIG. 23, the wheel track adjuster 42 is fully retracted, thereby positioning the wheels 30 as close together as possible. In this manner, the relative heights of the wheels across the track is maximized so that the wheeled vehicle may traverse a steep slope while maintaining the load carrier in an upright position.

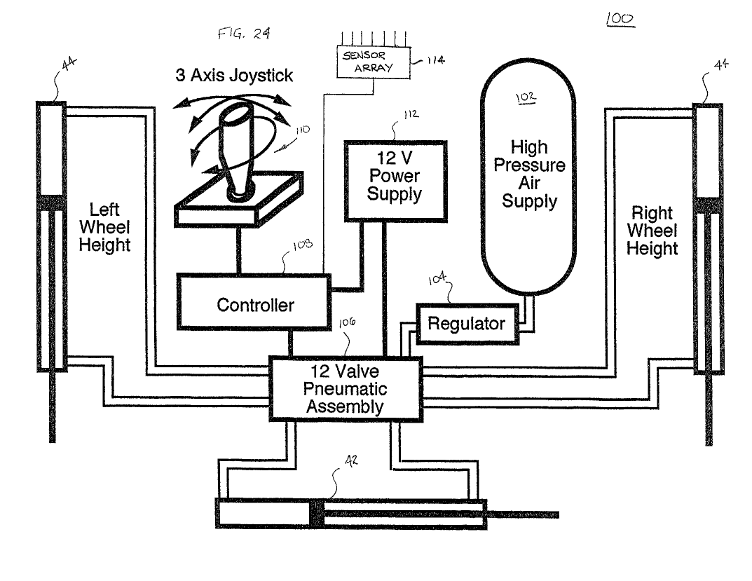

FIG. 24 shows one embodiment of a control system 100, which can control the wheel positioning system 40. In the embodiment shown, the control system 100 is a pneumatic control system, which utilizes pneumatic power provided by a high pressure air supply 102. However, those skilled in the art will appreciate that any type of fluid system, including hydraulic control systems, are equivalence.

The control system 100 also includes a pressure regulator 104, for regulating the output of the high pressure air supply 102. The output of the regulator 104 is provided to a pneumatic valve assembly 106. The pneumatic valve assembly is controlled by a controller 108, which is manipulated by a control device 110, such as a three axis joy stick. In one embodiment of the invention, the wheel positioning system control system 100 is operated by an occupant of the vehicle 10. However, in other embodiments, the control system may be manipulated by the person propelling the vehicle. Of course, embodiments utilizing multiple or redundant control systems are envisioned as well. By manipulating the control 110, the operator of the control system can direct high pressure air to one side of each wheel height adjuster 44 and the wheel track adjuster 42. In this manner, the height of each wheel and the track between the wheels can be adjusted.

The control power for control 108 may be provided by an electrical power supply 112, which will also provide valve operation power should it be required.

Of course, more sophisticated embodiments of the invention could include a sensor array 114 to sense various conditions relative to the stability of the vehicle and may provide automated control signals to the controller 108. Such embodiments could provide a semi or even fully automated wheel positioning system. For example, level sensors may sense that the vehicle 10 is traversing a slope and provide level signals directly to the controller 108, which would, in turn control valve assembly 106 to adjust the wheel height adjusters 44 and wheel track adjuster 42 to maintain the load carrier in a level orientation. Obstacle sensors could also be provided to sense when the height adjusters should be operated in unison to raise and lower the load carrier to avoid obstacles.

Additional sensors are contemplated as well. For example a load capacity sensor may sense the weight of the load being carried and be used to adjust the regulator 104 so as to provide a higher pneumatic power supply to the wheel positioners when the vehicle is carrying heavy loads. Conversely, when light loads are being carried, the pressure could be reduced so as to conserve the amount of high pressure air stored in the high pressure air supply 102.

The all-terrain wheeled vehicle 10 may also include independently height adjustable handles, which will aid a person propelling the vehicle to push or pull the vehicle while traversing a slope.

Of course, other means of positioning the wheels are contemplated by the present invention. For example, the pneumatic or hydraulic systems mentioned above may be replaced by a manually operable system, using gears, leads screws or the like, which could be manipulated by an occupant of the vehicle. This would add another level of participation in the rough terrain excursion by the vehicle occupant.

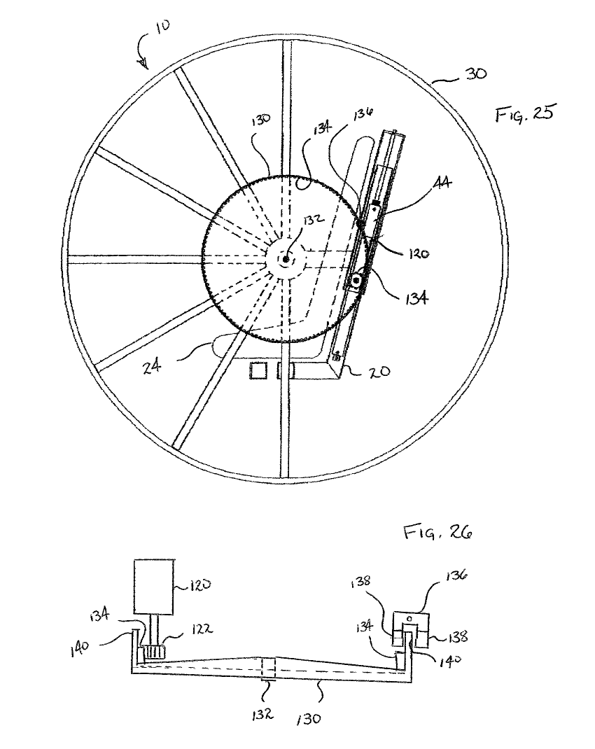

As indicated above, one or more alternative embodiments of the wheeled vehicle of the present invention may include power assisted drive mechanisms to assist a person pulling, pushing or otherwise manually propelling and directing the movement of the wheeled vehicle. The components that would be required to be added to the embodiments described above in order to add a power drive feature to disclosed wheeled vehicle are shown in FIGS. 25-26.

One fundamental requirement is that any drive mechanism must be fixed in position with respect to the wheels so that it can engage and propel the wheels. Accordingly, as shown in FIG. 25, a drive motor 120 is attached to one or more wheel height positioning cylinders 44. The drive motor 120 may be a pneumatic motor, in which case the same high pressure air source described above can be utilized to provide drive power to the motor. Preferably, the drive motor will be selectively engagable to allow an operator to selectively engage and disengage the drive motor so as to eliminate any drag associated with such a motor on the vehicle when the motor is not being utilized. Those skilled in the art will appreciate that various configurations for selectively engaging the drive motor are contemplated by the invention and include configurations similar to those utilized by starter motors for various internal combustion engines. In such configurations, a drive gear is positioned along a longitudinal axis of the motor to allow the drive gear to engage teeth on a part to be rotated when the motor is engaged and to be retracted along the axis otherwise.

In the power assisted drive embodiment herein described, one or both wheels 30 of the vehicle will be equipped with a drive hub 130, the center of which will rotationally engage the wheel's axle 132. Each drive hub will include a frictionally engagable drive surface 134, which will be engaged by a rotating driver 122, such as a drive wheel or sprocket provided by each drive motor 120. In the embodiment shown the frictionally engagable drive surface 134 is provided as a toothed drive surface 134 on an inner surface of the drive hub 130. However, such a frictionally engagable surface may take other forms which are well known to those skilled in the art of drive mechanisms, including drive disk and plate mechanisms or the like.

Of course, other types of drive motors, including electric motors are considered to by within the spirit and scope of the present invention.

In any event, regardless of the mechanism by which drive power is provided to one or both vehicle wheels, one or both vehicle wheels may also include a frictional brake mechanism, which may be selectively operated by an operator of the vehicle to slow the vehicle down when descending hills and such. In the embodiment shown in FIG. 26, the brake mechanism 136 may be similar to a bicycle-type friction brake, wherein brake pads 138 are positioned on opposite sides of a braking surface 140 of the rotating drive hub 130 so as squeeze the braking surface intermediate the brake pads and provide sufficient frictional resistance to slow down the hub (along with its associated wheel) and thus slow down or stop the vehicle. In such a configuration, the brake mechanism 136 may be operated using a lever, cable and fulcrum system similar to a bicycle brake.

As shown in FIG. 26, the braking surface 140 of the drive hub 130 may be adjacent to the drive surface 134. However, in an embodiment wherein a non-toothed drive surface is utilized, the braking surface 138 and drive surface 134 may be one in the same.

Accordingly, the disclosed all-terrain wheeled vehicle will provide assisted access to locations previously inaccessible to disabled persons. It also has a number of alternative applications, such as rough terrain search and rescue.

Modifications and substitutions by one ordinary skill in the art are considered to be within the scope of the present invention, which shall not be limited except by the claims, which follow.

What is claimed is:

1. An all-terrain wheeled vehicle comprising:
a frame having a handle assembly extending from a first end thereof, said handle assembly for allowing a person to propel the wheeled vehicle;
at least one pair of large diameter wheels disposed on opposite sides of the frame;
a load carrier disposed intermediate the pair of large diameter wheels; and
a wheel positioning system including a wheel track adjuster for adjustably positioning said wheels a desired distance from each other and a wheel height adjuster for individually adjusting the height of each of the large diameter wheels with respect to the load carrier.

2. The all-terrain wheeled vehicle of claim 1, wherein the large diameter wheels have a diameter substantially larger than five feet.

3. The all-terrain wheeled vehicle of claim 1, wherein the large diameter wheels include suspension spokes.

4. The all-terrain wheeled vehicle of claim 1, wherein the handle assembly includes two independently height adjustable handle arms.

5. The all-terrain wheeled vehicle of claim 1, wherein the wheel positioning system comprises a pneumatic power supply, a wheel track adjustment pneumatic cylinder, a wheel height adjustment cylinder for each wheel and a pneumatic control system for controlling pneumatic power to each pneumatic cylinder to adjust the relative positions of each wheel with respect to the load carrier and each other.

6. The all-terrain wheeled vehicle of claim 5, wherein the pneumatic power supply includes a high pressure air tank containing a volume of high pressure air.

7. The all-terrain wheeled vehicle of claim 5, wherein the pneumatic control system includes a pneumatic valve assembly for directing pneumatic power to each pneumatic cylinder and a controller for controlling the valve assembly.

8. The all-terrain wheeled vehicle of claim 7, wherein the controller includes an electric power supply, an electronic valve controller and an operator input device for controlling the electronic valve controller.

9. The all-terrain wheeled vehicle of claim 1, wherein the wheel positioning system comprises a manually adjustable wheel track positioner.

10. The all-terrain wheeled vehicle of claim 1, wherein the wheel positioning system comprises a manually adjustable wheel height positioning system configured to independently adjust a wheel height of each wheel with respect to said load carrier.

11. The all-terrain wheeled vehicle of claim 1, wherein said load carrier comprises a chair.

12. The all-terrain wheeled vehicle of claim 1, wherein said load carrier comprises a baggage carrier for carrying baggage, tools, equipment and the like.

13. The all-terrain wheeled vehicle of claim 1, wherein said load carrier comprises a stretcher for carrying an occupant in a prone position.

14. The all-terrain wheeled vehicle of claim 1 further comprising a power assist drive mechanism.

15. The all-terrain wheeled vehicle of claim 14, wherein said power assist drive mechanism comprises at least one drive motor selectively engaging at least one drive hub provided on at least one vehicle wheel.

16. The all-terrain wheeled vehicle of claim 15, wherein said power assist drive mechanism comprises a rotating drive mechanism provided on each said drive motor, said rotating drive mechanism frictionally engaging a frictional drive surface on said at least one drive hub.

17. The all-terrain wheeled vehicle of claim 16, wherein said frictional drive surface comprises a toothed drive surface and wherein said drive mechanism comprises a toothed sprocket.

18. The all-terrain wheeled vehicle of claim 16, wherein said frictionally engaging, rotating drive surface comprises a smooth surface and wherein said drive mechanism comprises a friction drive wheel.

19. The all-terrain wheeled vehicle of claim 1 further comprising a braking system.

20. The all-terrain wheeled vehicle of claim 19, wherein said braking system comprises a frictional braking system provided for at least one of said pair of large diameter wheels, said frictional braking system configured to frictionally engage a braking surface associated with at least one of said pair of large diameter wheels.
